(19) United States
(12) Patent Application Publication
(10) Pub. No.: US 2003/0087557 A1
(43) Pub. Date: May 8, 2003

(54) ADAPTER FOR ELECTRICALLY CONNECTING SAMRT CARD TO MOTHERBOARD

(76) Inventor: Hung-Chi Yu, Hsi-Chihj (TW)

Correspondence Address: Wei Te (Joseph) Chung, Foxconn International, Inc., 1650 Memorex Drive, Santa Clara, CA, 95050, US

(21) Appl. No.: 10/032,087

(22) Filed: Dec. 21, 2001

(30) Foreign Application Priority Data
Nov. 7, 2001 (TW) 90219110

(51) Int. Cl. H01R 25/00

(52) U.S. Cl. 439/638

(57) ABSTRACT

An adapter (10) is used to electrically connect a smart card (20) to a notebook computer (40) which defines an insert slot (40a) thereof. The adapter comprises an insulating housing (12) for inserting into the insert slot of the notebook computer. A plurality of terminals (15) include mating portions (15a) secured within terminal receiving channels (13a) defined in the housing, and contact portions (15b) for contacting an inserted smart card, thereby electrically connecting the smart card to the computer through the insert slot.

### BACKGROUND OF THE INVENTION

1. Field of the Invention

The present invention relates to an adapter, and particularly to an adapter for electrically connecting a smart card to a motherboard mounted in a notebook computer.

2. Description of Related Art

Recently, the smart card has been applied in many fields such as personal computers due to their excellent performance. However, for a notebook computer, the smart card can not be directly connected thereto because the notebook computer does not define the insert slot for insertion of the smart card. As we all know, it is almost impossible to define a new insert slot because of the small size of the notebook computer. Furthermore, even if the smart card insert slot could be defined in the notebook computer, it clearly increases the overall cost. Accordingly, defining a new insert slot for the smart card in the notebook seems not to be advisable at least at the present time. On the other hand, the notebook computer generally defines an insert slot at a side thereof for insertion of a PCMCIA card so as to transfer signals between a motherboard mounted in the notebook computer and the PCMCIA card. Therefore, how to apply the smart card in the notebook computer without needing to define a new insert slot, i.e., using existing PCMCIA card insert slot of the notebook computer, becomes a critical issue.

### SUMMARY OF THE INVENTION

Accordingly, the object of the present invention is to provide an adapter for electrically connecting a smart card to a notebook computer using a PCMCIA card insertion slot of the notebook computer.

In order to achieve the object set forth, the adapter of the present invention includes a pair of half parts secured together. The pair of half parts define a receiving space therebetween. The adapter further includes an insulating housing and a plurality of terminals secured within the receiving space, respectively. Each terminal includes a mating portion secured within a terminal receiving channel of the housing and a contact portion protruding into the receiving space. In use, the adapter is first inserted into an insert slot defined at a side of a notebook computer, wherein the mating portions of the terminals contact with contacts of a complementary connector mounted in a motherboard in the notebook computer. Then the smart card is inserted into the receiving space, wherein a plurality of contact pads formed on a top surface of the smart card contact with the contact portions of the terminals in the receiving space, thereby electrically connecting the smart card to the motherboard of the notebook computer.

Other objects, advantages and novel features of the invention will become more apparent from the following detailed description of the preferred embodiment when taken in conjunction with the accompanying drawings.

### BRIEF DESCRIPTION OF THE DRAWINGS

FIG. 1 is an exploded view of an adapter of the present invention;

FIG. 2 is an exploded view of a notebook computer, a smart card and the assembled adapter of the present invention;

FIG. 3 is a view similar to FIG. 2 but showing that the smart card and the adapter are assembled to the notebook computer; and

### DETAILED DESCRIPTION OF THE INVENTION

Reference will now be made to the drawing figures to describe the present invention in detail.

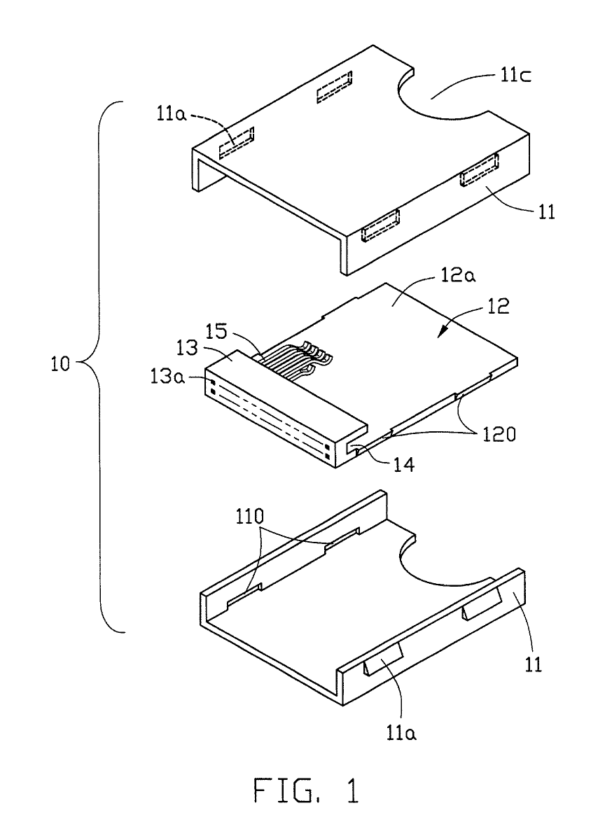

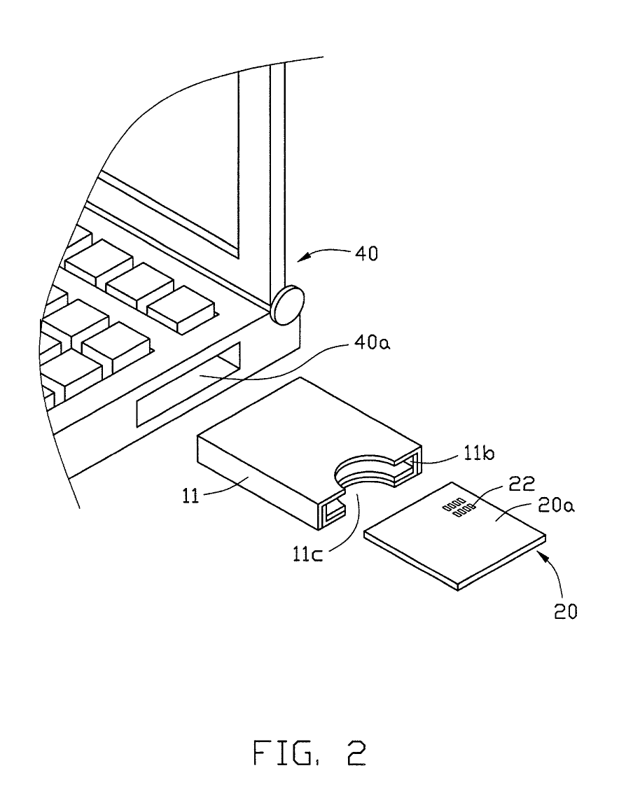

Referring to FIGS. 1 and 2, an adapter 10 of the present invention is used for electrically connecting a smart card 20 to a notebook computer 40. The computer 40 defines an insert slot 40a at a side thereof.

The adapter 10 includes a pair of half parts 11 vertically secured together by securing portions 11a. The pair of parts 11 together define an elongate receiving space 11b therebetween and a semicircular recess 11c at an end thereof. The pair of half parts 11 are formed to have a predetermined length greater than the depth of the insert slot 40a of the computer 40 so that a rear end of the pair of half parts 11 is disposed out of the insert slot 40a of the computer 40. The smart card 20 includes a plurality of contact pads 22 on a top surface 20a thereof and also has a predetermined length which is greater than the depth of the receiving space 11b but smaller than that of the pair of half parts 11.

The adapter 10 further includes a flat insulating housing 12 secured to the pair of half parts 11 by the engagement of the securing portions 120 and 110. The housing 12 has an upwardly extending block 13 at a front end thereof. The block 13 defines a plurality of terminal receiving channels 13a. A top portion of the block 13 protrudes toward a rear end opposite to the first end of the housing. Thus, a securing groove 14 is defined between the protruding portion of the block 13 and an upper surface 12a of the housing 12.

A plurality of terminals 15 are received within the receiving space 11b. Each terminal 15 has a mating portion 15a secured within a corresponding terminal receiving channel 13a, and a contact portion 15b protruding into the receiving space 11b and being spaced from the upper surface 12a of the housing 12.

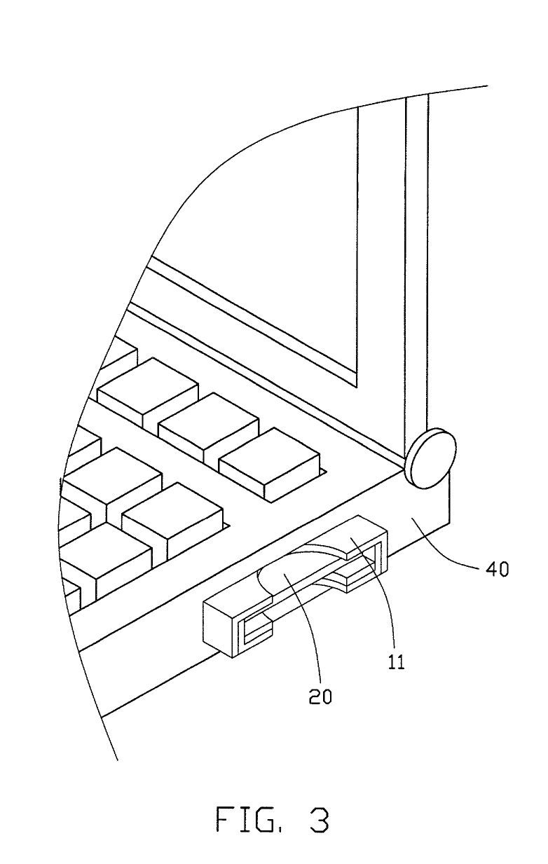

Referring to FIG. 3, in use, the assembled adapter 10 is first inserted into the insert slot 40a of the notebook computer 40, wherein the mating portions 15a of the terminals 15 mate with corresponding terminals 42 in the notebook computer 40. The smart card 20 is then inserted into the receiving space 11b of the adapter 10 wherein a frontmost portion of the smart card 20 is disposed in the groove 14 of the adapter 10. The contact pads 22 of the smart card 20 contact with contact portions 15b of the terminals 15. Rear ends of the pair of half parts 11 and the smart card 20 are both exposed outside of the insert slot 40a of the computer 40. The rear end of the smart card 20 is located in the semicircular recess 11c of the pair of half parts 11.

It is noted that the housing 12 of the adapter 10 can be formed integrally with one of the pair of half parts 11, or being formed of two halves to be further assembled together. In addition, the pair of half parts 11 of the adapter 10 can be also formed integrally.

A first advantage of the present invention is that the smart card 20 is electrically connected to the notebook computer 40 by the adapter 10 without needing to define a new insert slot in the notebook computer, thereby decreasing the overall costs.

A second advantage of the present invention is that the adapter 10 can be readily withdrawn from the insert slot 40a of the computer 40 because the rear end of the smart card 20 is situated in the recess 11c outside of the notebook computer 40.

A third advantage of the present invention is that the smart card 20 exposed out of the notebook computer 40 is covered by the rear end of the pair of half parts 11, thereby preventing the smart card from being touched by an external force.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adapter for electrically connecting a first card to an electrical component defining an insert slot thereof for insertion of a second card, the adapter comprising:
an insulating housing adapted to be arranged in the insert slot of the electrical component and defining a plurality of terminal receiving channels therein;
a plurality of terminals including mating portions secured within the terminal receiving channels of the housing and electrically contacting the electrical component, and contact portions for contacting the inserted first card, thereby electrically connecting the first card to the electrical component.

2. The adapter as claimed in claim 1, wherein the housing has a flat shape and defines an upward extending block at a front end thereof, the terminal receiving channels being defined within the block.

3. The adapter as claimed in claim 2, wherein a top of the block extends toward a rear end of the housing opposite to the front end, thereby defining a groove between the rearward extending portion of the block and an upper surface of the housing for retaining the inserted first card.

4. The adapter as claimed in claim 3, wherein the contact portions of the terminals include arc portions projecting toward the upper surface of the housing for contacting the inserted first card.

5. The adapter as claimed in claim 1, wherein a rear end of the first card is disposed out of the insert slot of the electrical component when fully inserted.

6. The adapter as claimed in claim 1, further including a pair of half parts secured together and defining an elongate receiving space therebetween, the housing being secured within the receiving space.

7. The adapter as claimed in claim 6, wherein the pair of half parts define an opening at a front end thereof to provide mating space for the electrical component, and an opening at a rear end thereof for insertion of the first card.

8. The adapter as claimed in claim 7, wherein the pair of half parts have a predetermined length longer than the depth of the insert slot to expose the rear end of the pair of half parts out of the insert slot when the first card is fully inserted into the insert slot.

9. The adapter as claimed in claim 8, wherein the pair of half parts define a recess at the rear end thereof to expose a rear end of the first card outward.

10. The adapter as claimed in claim 7, wherein the recess has a semicircle shape.

11. The adapter as claimed in claim 10, wherein the receiving space has a predetermined depth so that the rearmost end of the first card is disposed in the recess of the pair of half parts after the first card is inserted into the adapter, thereby protecting the first card from being touched by an external force and also providing a readily withdrawing operation of the first card from the inserted slot.

12. The adapter as claimed in claim 1, wherein the electrical component is a notebook computer.

13. The adapter as claimed in claim 1, wherein the first card is a smart card and the second card is a PCMCIA card.

14. An adapter for connecting a smart card to a motherboard which is mounted in a notebook computer, comprising:
an insulating shell defining an elongate receiving space therein along an insertion direction of the smart card for insertion of the smart card;
a plurality of terminals received within the receiving space along the insertion direction, each terminal including a mating portion for contacting with a complementary contact mounted in the motherboard of the computer, and a contact portion for contacting with an inserted smart card thereby establishing electrical connection between the smart card and the computer.

15. The adapter as claimed in claim 14, wherein the insulating shell is assembled by two half parts secured together along a direction vertical to the insertion direction.

16. The adapter as claimed in claim 14, wherein an insulating housing is disposed in the receiving space, the mating portions of the terminals being secured within the housing.

17. A card assembly for insertion into an insert slot defined in an electrical component, comprising:
a smart card having a plurality of contact pads formed at a front top surface thereof;
an adapter for receiving the smart card therein, including:
a receiving space opening at a front end thereof;
a guide portion defined at a rear end of the receiving space opposite to the front end for guiding the smart card into the receiving space and for receiving the card therein;
a recess defined at the rear end of the receiving space for assisting in withdrawal of the smart card from the electrical component; and
a plurality of terminals received in the receiving space near the front end, each terminal comprising a mating portion for electrically connecting to the electrical component, and a contact portion engaged to the contact pads of the smart card, thereby electrically connecting the smart card to the electrical component.

18. A interconnection system for use with a PCMCIA card and a Smart card, comprising:
a data storage device defining an insert slot in one face thereof, said insert slot being configured to receive said PCMCIA card therein;
an adaptor including a housing defining an outer contour in compliance with that of said PCMCIA card and an inner configuration in compliance with that of said Smart card;
said housing defining on a front portion thereof two rows of passageways for receiving a PCMCIA connector which is located around an inner end of the insert slot;
a plurality of contacts disposed in some of said passageways, respectively, with thereof front ends adapted to be mechanically and electrically engaged with the PCMCIA connector; wherein
rear ends of said contacts are arranged in a pattern in compliance with conductive pads on said Smart card, respectively.

19. The system as claimed in claim 18, wherein said housing is inserted into the insert slot with the front portion mated with the PCMCIA connector and with thereof a rear portion extending out of said insert slot.

20. The system as claimed in claim 19, wherein said housing defines a recess for easy access to the Smart card in said housing from an exterior in a vertical direction perpendicular to said insert slot.
